(19) United States
(12) Patent Application Publication
(10) Pub. No.: US 2024/0300371 A1
(43) Pub. Date: Sep. 12, 2024

(54) METHOD OF CHARGING ELECTRIFIED VEHICLE AND ELECTRIFIED VEHICLE CHARGING SYSTEM

(71) Applicant: TOYOTA JIDOSHA KABUSHIKI KAISHA, Toyota-shi (JP)

(72) Inventors: Keiji KAITA, Miyoshi-shi (JP); Yoshikazu Suzuki, Toyota-shi (JP); Hirotaka Omisha, Nisshin-shi (JP); Takahiko Hirasawa, Toyota-shi (JP)

(73) Assignee: TOYOTA JIDOSHA KABUSHIKI KAISHA, Toyota-shi (JP)

(21) Appl. No.: 18/390,685

(22) Filed: Dec. 20, 2023

(30) Foreign Application Priority Data
Mar. 7, 2023 (JP) 2023-034635

(51) Int. Cl. B60L 53/66; B60L 53/16; B60L 53/35; G06Q 10/0631

(52) U.S. Cl. CPC B60L 53/665; B60L 53/16; B60L 53/35; G06Q 10/06311

(57) ABSTRACT

A method of charging an electrified vehicle using charging equipment that is configured to automatically charge an electrified vehicle includes user authentication to be performed through communication between the charging equipment and a user terminal linked to the electrified vehicle, and when the user authentication is successful and the charging equipment becomes capable of charging the electrified vehicle, notifying the user terminal that the electrified vehicle can be charged.

### CROSS-REFERENCE TO RELATED APPLICATION

This application claims priority to Japanese Patent Application No. 2023-034635 filed on Mar. 7, 2023, incorporated herein by reference in its entirety.

### BACKGROUND

### 1. Technical Field

The present disclosure relates to a method of charging an electrified vehicle and an electrified vehicle charging system.

### 2. Description of Related Art

Japanese Unexamined Patent Application Publication No. 2000-270411 (JP 2000-270411 A) discloses charging equipment (automatic charging device) configured to automatically charge an electrified vehicle. This automatic charging device extends a charging arm to search for a charging socket (charging port) of the electrified vehicle when the electrified vehicle is parked. The automatic charging device charges the electrified vehicle by fitting the charging arm with the charging socket.

The automatic charging device described in JP 2000-270411 A starts preparations for charging when an electrified vehicle is parked, for the purpose of shortening the time from the vehicle stop to the end of charging. The automatic charging device starts charging of the electrified vehicle when preparations for charging are completed. In JP 2000-270411 A, it is not assumed that preparations for charging are performed and charging of the electrified vehicle is started in a situation where a user of the electrified vehicle is located away from the electrified vehicle. With the technique described in JP 2000-270411 A, it is difficult to appropriately charge the electrified vehicle using the automatic charging device in such a situation.

### SUMMARY

The present disclosure has been made to address the above issue. The purpose of the present disclosure is to facilitate automatic charging of an electrified vehicle being appropriately executed by charging equipment, even in a situation where a user of the electrified vehicle is located away from the electrified vehicle.

A first aspect of the present disclosure provides a method of charging an electrified vehicle using charging equipment configured to automatically charge the electrified vehicle. This method includes:
performing user authentication through communication between the charging equipment and a user terminal linked to the electrified vehicle; and
when the user authentication is successful and the charging equipment is able to charge the electrified vehicle, notifying the user terminal that the electrified vehicle is chargeable.

According to the above method, the charging equipment can easily automatically charge the electrified vehicle appropriately, even in a situation where a user of the electrified vehicle is located away from the electrified vehicle. Automatic charging is charging in which preparations before the start of charging (e.g. plug connection in contact charging, positioning in non-contact charging, etc.) are automatically performed.

A second aspect of the present disclosure provides an electrified vehicle charging system including charging equipment that executes the method of charging an electrified vehicle discussed above.

According to the above system, the method of charging an electrified vehicle discussed above is suitably executed.

According to the present disclosure, it is possible to facilitate automatic charging of an electrified vehicle being appropriately executed by charging equipment, even in a situation where a user of the electrified vehicle is located away from the electrified vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining an overview of an electrified vehicle charging system according to an embodiment of the present disclosure;

FIG. 2 is a diagram for explaining the process executed by the control device of the charging equipment when an electrified vehicle stops in a parking slot of a parking lot in the charging system shown in FIG. 1;

FIG. 3 is a flowchart showing processing related to automatic charging executed by the control device of the charging equipment shown in FIG. 1;

FIG. 4 is a diagram showing a first modification of the charging equipment shown in FIG. 1; and

FIG. 5 is a diagram showing a second modification of the charging equipment shown in FIG. 1.

### DETAILED DESCRIPTION OF EMBODIMENTS

An embodiment of the present disclosure will be described in detail with reference to the drawings. In the drawings, the same or corresponding parts are denoted by the same reference signs and the description thereof will not be repeated.

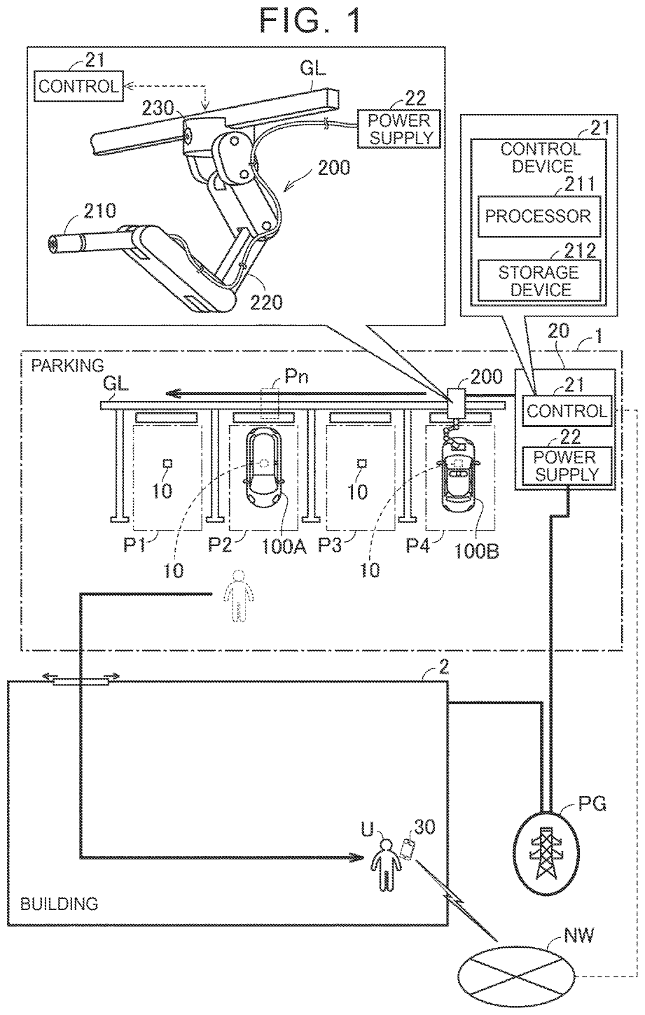

FIG. 1 is a diagram for explaining an overview of an electrified vehicle charging system according to an embodiment of the present disclosure. Referring to FIG. 1, this charging system includes a parking lot 1 and a building 2. Parking lot 1 has parking slots P1 to P4. Each of the parking slots P1 to P4 is provided with a vehicle detection sensor 10 that detects a stop within the parking frame. The vehicle detection sensor 10 may be a type of sensor buried in the ground (for example, a loop coil) or a non-buried type sensor (for example, an area sensor).

In this embodiment, building 2 is a commercial facility. The building 2 may be a commercial facility where shopping is performed (for example, a convenience store or a department store) or a commercial facility where services are provided (for example, a bank or a restaurant). However, the building 2 is not limited to a commercial facility, and may be another building (for example, an apartment complex, a factory, or a public facility).

In this embodiment, user U is a user of building 2. User U rides vehicle 100A and moves to parking lot 1 for building 2. User U parks vehicle 100A in parking slot P2, for example. Parking lot 1 is equipped with charging equipment.

The charging equipment provided in the parking lot 1 is configured to charge a power storage device included in an electrified vehicle (for example, vehicles 100A, 100B) that has stopped in one of the parking slots P1 to P4. This charging equipment includes a power feeding robot 200, a guide rail GL, and a drive unit 20. The guide rail GL is connected to the power feeding robot 200 and functions as a track for moving the power feeding robot 200. Power feeding robot 200 moves along guide rail GL. The drive unit 20 includes a control device 21 that controls the power feeding robot 200 and a power supply circuit 22 that supplies power to the power feeding robot 200. In this embodiment, the drive unit 20 is provided in the parking lot 1, but the drive unit 20 may be installed at any location. The drive unit 20 may be provided inside the power feeding robot 200.

The control device 21 includes a processor 211 and a storage device 212. Various processes are executed by the processor 211 executing programs stored in the storage device 212. For example, the control device 21 receives the detection results from the vehicle detection sensor 10 of each of the parking slots P1 to P4, and determines the state (stopped/vacant) of each parking space based on these detection results. Note that a surveillance camera or a 3D-LiDAR parking management system may be used instead of the vehicle detection sensor. Further, the various processes performed by the control device 21 are not limited to execution by software, but can also be executed by dedicated hardware (electronic circuits).

Each electrified vehicle (including vehicles 100A and 100B) that uses the charging equipment is registered in advance in the charging equipment (storage device 212). Specifically, each user terminal (including the user terminal 30) linked to each electrified vehicle has application software (hereinafter referred to as a “charging application”) installed therein for using the charging equipment. Ru. By the charging application, the identification information (terminal ID) of the user terminal is registered in the storage device 212 in association with the identification information (vehicle ID) of the corresponding electrified vehicle. The user terminal on which the charging application is installed can exchange information with the control device 21. The control device 21 manages user information and vehicle information by distinguishing them by identification information (for example, terminal ID and vehicle ID).

In this embodiment, user information and vehicle information are stored in storage device 212 as registration information. The user information includes, for example, the user's personal information (name, contact information, fee information, etc.), the communication address of the user terminal, and the identification information (vehicle ID) of the vehicle associated with the user terminal. The vehicle information includes, for example, vehicle specification information (dimensions, charging performance, position of charging port, etc.) and identification information (terminal ID) of a user terminal associated with the vehicle. The storage device 212 also stores information regarding the parking lot 1 (position information of each parking slot, etc.).

The user terminal 30 linked to the vehicle 100A is a terminal that can be carried by the user U. In this embodiment, a smartphone equipped with a touch panel display is employed as the user terminal 30. The smartphone has a built-in computer. However, the present disclosure is not limited to this, and any terminal can be used as the user terminal 30. For example, a portable game machine, a wearable device, an electronic key, etc. can also be used as the user terminal 30.

User terminal 30 includes a wireless communication device that can access communication network NW. The control device 21 is connected to the communication network NW. The communication network NW is, for example, a wide area network constructed by the Internet and wireless base stations. The control device 21 and the user terminal 30 are configured to be able to communicate with each other via the communication network NW.

The power system PG (external power supply) supplies power to each of the building 2 and the drive unit 20. The power system PG includes a power transmission and distribution network constructed by power transmission and distribution equipment, and power generation equipment that supplies power to the power transmission and distribution network. In this embodiment, power output from the power system PG is input to each of the distribution board (not shown) of the building 2 and the power supply circuit 22 of the drive unit 20.

The power supply circuit 22 converts the power supplied from the power system PG into power for power feeding, and supplies the converted power to the power feeding robot 200. The power supply circuit 22 may perform power conversion according to a command from the control device 21. The control device 21 may specify power parameters for power feeding (for example, at least one of voltage and current) and control the power supply circuit 22 so that the specified power is supplied to the power feeding robot 200.

The power feeding robot 200 includes a charging gun 210 (charging connector section), an arm 220, a camera 230, and various actuators (not shown). The power feeding robot 200 includes an actuator (for example, a motor) for displacing the power feeding robot 200 along the guide rail GL. The control device 21 sets one of the parking slots P1 to P4 as a target parking frame. The control device 21 controls the actuator so that the power feeding robot 200 moves to the target parking frame along the guide rail GL. The camera 230 generates a video signal indicating the surrounding environment by capturing an image of the surroundings, and outputs the video signal to the control device 21. The control device 21 can use the video signal to grasp, for example, the situation of the target parking slot (for example, the stopping position of the electrified vehicle in the target parking slot). The control device 21 moves the power feeding robot 200 to the target parking slot, and causes the power feeding robot 200 to supply power to the electrified vehicle parked in the target parking frame. An electrified vehicle parked in any of the parking slots P1 to P4 can receive power from the power feeding robot 200.

The charging gun 210 is located at the tip of the arm 220 and is configured to be connectable to a charging port of an electrified vehicle. The charging gun 210 receives power from the power supply circuit 22 and supplies the power to the charging port of the connected electrified vehicle. Arm 220 moves to displace charging gun 210 according to a control command from control device 21. Arm 220 includes a plurality of joints and an actuator (for example, a motor) that moves each joint. The control device 21 sets a target position within the range of motion of the charging gun 210 in three-dimensional space, and controls the arm 220 so that the charging gun 210 is located at the target position. By setting the position of the charging port of the electrified vehicle as the target position, the charging gun 210 can be connected to the charging port of the electrified vehicle.

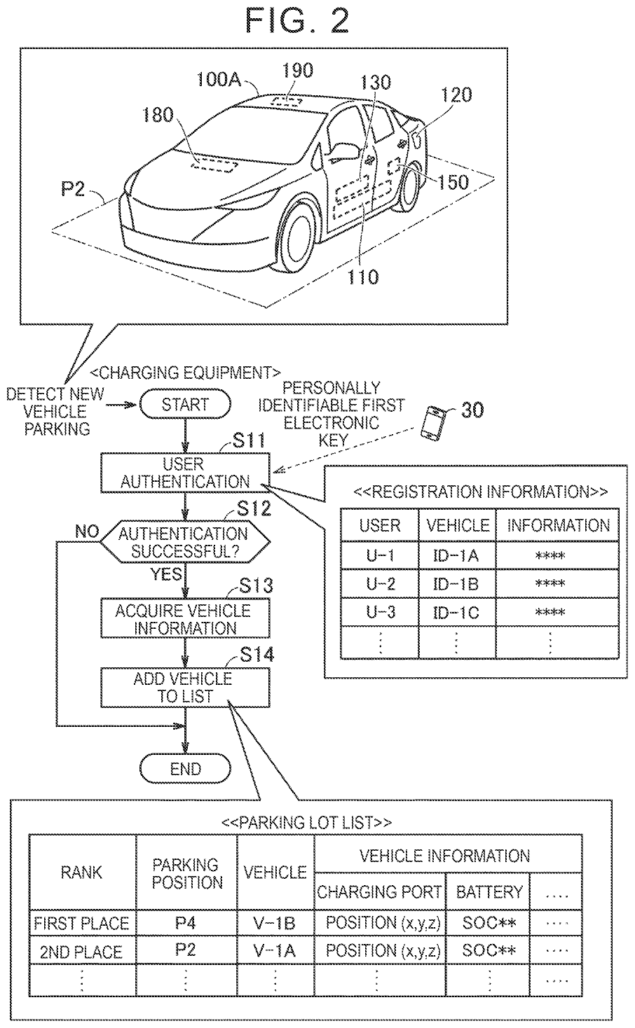

FIG. 2 is a diagram for explaining the process executed by the control device 21 of the charging equipment when the electrified vehicle stops at a parking slot (any of the parking slots P1 to P4) in the parking lot 1.

Referring to FIG. 2, vehicle 100A communicates with battery 110, inlet 120, charging circuit 130, electronic control unit (hereinafter referred to as “ECU”) 150, human machine interface (HMI) 180, and A device 190 is provided. ECU 150 includes a processor and a storage device. The vehicle 100A is an electrified vehicle configured to be able to travel using electric power stored in a battery 110. The vehicle 100A is, for example, a battery electric vehicle (BEV) without an internal combustion engine. As the battery 110, a known vehicle power storage device (a liquid secondary battery, an all-solid secondary battery, an assembled battery, etc.) can be employed.

Inlet 120 includes a charging port and a charging lid. The charging lid is configured to be openable and closable by the user or the ECU 150. The charging lid covers the charging port when closed and exposes the charging port when opened. The charging circuit 130 is a circuit that charges the battery 110 using power supplied to the charging port from outside the vehicle. Charging circuit 130 is controlled by ECU 150.

HMI 180 includes a navigation system. HMI 180 may include a touch panel display or a smart speaker that accepts audio input. Inputs from the user to HMI 180 and detection values from various sensors (not shown) mounted on vehicle 100A are input to ECU 150. The vehicle 100A is equipped with a position sensor, a vehicle speed sensor, an accelerator sensor, an outside temperature sensor, a battery sensor, a charging lid opening/closing sensor, a charging gun connection sensor, and the like. Battery sensors include various sensors that detect the status of battery 110 (e.g., voltage, current, temperature, and SOC). The State of Charge (SOC) indicates, for example, the ratio of the current amount of stored power to the amount of stored power in a fully charged state.

ECU 150 communicates with control device 21 through communication device 190. The communication device 190 may include a wireless communication device (e.g., a Data Communication Module (DCM)) that can access the communication network NW. Alternatively, the communication device 190 may directly communicate wirelessly with the control device 21 without using the communication network NW. When the power feeding robot 200 is charging the battery 110 mounted on the vehicle 100A, the vehicle 100A sequentially transmits detection results by an on-vehicle sensor (for example, an SOC sensor) to the control device 21.

When the electrified vehicle stops at a parking slot (any of parking slots P1 to P4) in the parking lot 1, the control device 21 executes a series of processes (S11 to S14) shown in the flowchart in FIG. 2. “S” in the flowchart means a step. Below, steps S11 to S14 will be described taking as an example a case where the vehicle 100A stops at the parking slot P2. When the control device 21 detects, for example, using the vehicle detection sensor 10 that the vehicle 100A has stopped at the parking slot P2, a series of processes described below are started.

In S11, the control device 21 receives the vehicle ID from the vehicle 100A, and starts communication with the user terminal 30 linked to the vehicle 100A. Then, the control device 21 performs user authentication through communication with the user terminal 30 while referring to the registration information in the storage device 212. The registration information includes the vehicle information and user information described above. Specifically, the control device 21 requests the user terminal 30 for a first electronic key that can identify the individual (user U). The first electronic key may be a private key registered in the control device 21 in advance. Alternatively, an electronic key valid for only one authentication may be issued. When the user terminal 30 receives a request for the first electronic key from the control device 21, the charging application is activated in the user terminal 30. The charging application requests the user U to input the first electronic key. Then, when the first electronic key is input by the user U, the first electronic key is transmitted from the user terminal 30 to the control device 21. User U may register the first electronic key in user terminal 30 in advance to omit input work.

In S12, the control device 21 determines whether user authentication has been successful. When the control device 21 receives the first electronic key from the user terminal 30, it determines that the user authentication has been successful. If the user terminal 30 does not receive the first electronic key even after a predetermined period of time has passed since the request, the user terminal 30 determines that the user authentication has failed. If the user authentication fails (NO in S12), the control device 21 ends the processing flow of FIG. 2 without performing the processing after S13.

If the user authentication is successful (YES in S12), the control device 21 acquires information regarding the vehicle 100A in S13. Specifically, control device 21 acquires information indicating the current state of vehicle 100A (for example, the SOC of battery 110) from vehicle 100A. Further, the control device 21 reads vehicle information regarding the vehicle 100A (for example, XYZ coordinates indicating the position of the charging port included in the vehicle 100A) from the storage device 212.

In subsequent S14, the control device 21 adds the information regarding the vehicle 100A acquired in S13 to the parking lot list. When the process of S14 is executed, the process flow of FIG. 2 ends.

The parking lot list is stored in the storage device 212. The parking lot list shows information regarding electrified vehicles (hereinafter referred to as “parked vehicles”) parked in the parking lot 1. More specifically, the parking lot list shows the vehicle ID of the parked vehicle, the parking position (any of the parking slots P1 to P4), specification information, and current state. If multiple electrified vehicles are parked in parking lot 1, the parking lot list further indicates the order of charging for those parked vehicles. In this embodiment, the control device 21 determines the order of charging so that the electrified vehicles parked in the parking lot 1 first are charged first. However, the present disclosure is not limited to this, and the control device 21 may change the order of charging based on the remaining battery charge (SOC) of each parked vehicle. For example, the charging order of parked vehicles whose remaining battery level is less than or equal to a predetermined value may be accelerated. Furthermore, the control device 21 may advance the charging order of parked vehicles ridden by users who meet predetermined preferential conditions (for example, users who have reserved charging in advance or users who have paid a special fee).

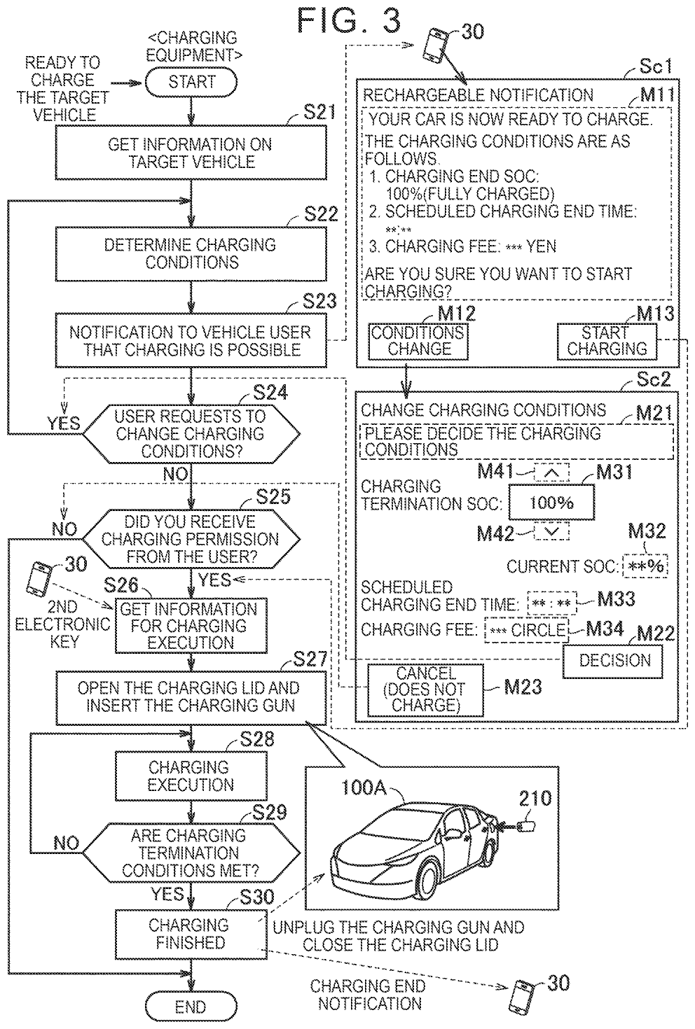

When the vehicle 100A arrives at the parking lot 1, for example, as shown in FIG. 1, the charging equipment (power feeding robot 200) may be being used by another electrified vehicle (vehicle 100B). In this case, when the vehicle 100A stops at the parking slot P2, the vehicle 100A is registered in the parking lot list so that the vehicle 100A is charged next to the vehicle 100B according to the processing flow shown in FIG. 2. User U may use building 2 while waiting for charging. For example, after parking the vehicle 100A in the parking slot P2, the user U carries the user terminal 30 and enters the building 2. Then, the user U uses the building 2 while carrying the user terminal 30. Specifically, the user U shops in the building 2 and receives services. When charging of vehicle 100B is completed while user U is using building 2, the charging equipment becomes able to charge vehicle 100A. The control device 21 starts a series of processes shown in FIG. 3, which will be described below. FIG. 3 is a flowchart showing processing related to automatic charging executed by the control device 21.

Referring to FIG. 3, in S21, control device 21 acquires information regarding the target vehicle (vehicle 100A) that is about to start charging from the parking lot list. In subsequent S22, the control device 21 determines charging conditions. The charging conditions include, for example, power supply conditions (for example, parameters of electric power supplied by the charging equipment) and charging termination conditions. The control device 21 determines power supply conditions according to, for example, specification information of the vehicle 100A. Further, the control device 21 determines the charge end SOC regarding the charge termination condition. In this embodiment, when the SOC of battery 110 reaches the charge end SOC while charging battery 110 mounted on vehicle 100A, the charge end condition is satisfied. In this embodiment, the initial value of the charge end SOC is set to the SOC value (100%) indicating full charge. However, the charging end SOC can be changed by the user (see screen Sc2 described later). Note that the initial value of the charging end SOC can be changed as appropriate.

In subsequent S23, the control device 21 notifies the user terminal 30 linked to the vehicle 100A that charging of the battery 110 mounted on the vehicle 100A (hereinafter also simply referred to as “charging the vehicle 100A”) is enabled. At this time, the control device 21 determines the scheduled charging end time and charging fee (the fee paid by the user U after charging) for charging the vehicle 100A based on the current state of the vehicle 100A and the charging conditions determined in S22. Control device 21 transmits to user terminal 30 a notification signal including the current state of vehicle 100A, the charging conditions determined in S22, the scheduled charging end time, and charging fee information. When the user terminal 30 receives the notification signal, it displays the screen Sc1. Screen Sc1 and screen Sc2, which will be described later, are displayed on the touch panel display and accept input from user U.

The screen Sc1 includes a display section M11 indicating the charging conditions, an operation section M12 (for example, an operation button) that accepts input for changing the charging conditions indicated by the display section M11, and an operation section M13 (for example, an operation button) that accepts input for starting charging under the charging conditions indicated by the display section M11. Display section M11 displays charging end SOC, scheduled charging end time, and charging fee information. Display section M11 further displays a message informing user U that charging of vehicle 100A is now possible, and a message prompting user U to operate either operation section M12 or M13.

Then, when the user U operates the operation section M12, the user terminal 30 displays the screen Sc2. The screen Sc2 includes a message M21 prompting the user U to decide charging conditions, a display section M31 indicating the charging end SOC, a display section M32 indicating the current SOC of the battery 110 of the vehicle 100A, a display section M33 indicating the scheduled charging end time, a display section M34 that shows the charging fee, operation sections M41 and M42 for changing the charging end SOC, an operation section M22 (for example, an operation button) that accepts an input for determining the charging end SOC indicated by the display section M31, and an operation section M23 (for example, an operation button) that accepts an input for canceling charging.

User U can increase or decrease the charge end SOC within the range from the lower limit value to the upper limit value by operating the operation section M41 or M42. The upper limit value of the charge end SOC may be a value indicating full charge. The lower limit value of the charge end SOC may be the current SOC value (current battery remaining amount) or a higher value. When the operation section M41 or M42 is operated, the changed charging end SOC is displayed on the display section M31. Furthermore, when the charging end SOC is changed using the operation sections M41 and M42, a calculation is performed by the user terminal 30. The values shown on display sections M33 and M34 change to values corresponding to the changed charge end SOC.

When the user U completes changing the charging conditions, the user U operates the operation section M22. After transmitting the notification signal to the user terminal 30 in S23, the control device 21 determines in S24 whether or not a request to change the charging conditions has been received from the user U. If the user U operates the operation section M12 on the screen Sc1 and operates the operation section M22 on the screen Sc2, YES is determined in S24. The process returns to S22. Then, the control device 21 adopts the charging condition changed by the user U in S22. In subsequent S23, the control device 21 transmits a notification signal according to the charging condition to the user terminal 30. As a result, the user terminal 30 displays the screen Sc1 again. However, the display section M11 of the screen Sc1 shows the charging conditions changed by the screen Sc2. When approving the charging indicated by the display section M11, the user U operates the operation section M13.

If the operation section M13 is operated on the screen Sc1, the determination in S24 is NO, and the process proceeds to S25. In S25, the control device 21 determines whether charging permission has been received from the user U. The fact that the user U operates the operation section M13 on the screen Sc1 means that the user U has permitted the charging shown on the screen Sc1. If the operation section M13 is operated on the screen Sc1, YES is determined in S25, and the process proceeds to S26.

In S26, the control device 21 receives the second electronic key issued by the user terminal 30. The second electronic key is a signal that allows external charging equipment (control device 21) to remotely control vehicle 100A regarding charging of battery 110. The second electronic key may be a private key registered in the user terminal 30 in advance. Alternatively, an electronic key that is valid only for one charge may be issued.

The second electronic key may allow remote control of the charging equipment with predetermined constraints (e.g., limited time). The control device 21 that has received the second electronic key can remotely control the vehicle 100A under conditions permitted by the second electronic key. In remote control, for example, ECU 150 of vehicle 100A receives a command from control device 21 via wireless communication, and controls vehicle 100A in accordance with the command.

In subsequent S27, the control device 21 controls the power feeding robot 200 so that the power feeding robot 200 moves to the position (position Pn in FIG. 1) corresponding to the target parking frame (parking slot P2). Subsequently, the control device 21 opens the charging lid of the vehicle 100A to expose the charging port of the vehicle 100A by remote control. Furthermore, the control device 21 sets the position of the inlet 120 (charging port) of the vehicle 100A as a target position, and controls the power feeding robot 200 so that the charging gun 210 (charging connector section) is connected to the charging port of the vehicle 100A. Control device 21 may search for the charging port of vehicle 100A using camera 230, extend arm 220, and fit charging gun 210 into the charging port. As a result, the vehicle 100A enters a plug-in state (a state in which it is electrically connected to a power source outside the vehicle).

In subsequent S28, the control device 21 controls the power supply circuit 22 so that power is supplied from the charging gun 210 to the charging port of the vehicle 100A. Specifically, control device 21 performs charging of vehicle 100A according to the charging conditions determined in S22. In subsequent S29, the control device 21 determines whether the charging termination condition determined in S22 is satisfied. As long as the charging termination condition is not satisfied (NO in S29), S28 and S29 are repeated, and charging of the vehicle 100A (S28) is continuously executed. On the other hand, if the charging termination condition is satisfied (YES in S29), the process proceeds to S30. This completes charging of the vehicle 100A.

In S30, the control device 21 executes a predetermined charging termination process. Specifically, control device 21 controls power feeding robot 200 so that charging gun 210 is removed from the charging port of vehicle 100A. Further, the control device 21 closes the charging lid of the vehicle 100A by remote control. This covers the charging port with the charging lid. The charging termination process may further include a charging termination notification to the user terminal 30. In S30, control device 21 may transmit a signal to user terminal 30 to inform user U that charging of vehicle 100A has ended. When the process of S30 is executed, the process flow of FIG. 3 ends.

Even if the determination in S25 is NO, the processing flow in FIG. 3 ends. In this case, the control device 21 excludes the vehicle 100A from the charging order indicated by the parking lot list (FIG. 2). In this embodiment, the user U can request the charging equipment not to charge the vehicle 100A by operating the operation section M23 on the screen Sc2. However, if the vehicle 100A continues to be parked in the parking slot P2 even after a predetermined period of time has passed since the exclusion, the control device 21 may return the vehicle 100A to the charging order and perform the processing flow of FIG. 3 regarding the vehicle 100A. According to this configuration, when the user U stays in the building 2 for a long time, it becomes easier to yield the charging order to another electrified vehicle.

Note that when the vehicle 100A departs from the parking slot P2, the control device 21 excludes the vehicle 100A from the parking lot list.

As explained above, the method of charging an electrified vehicle according to this embodiment includes the series of processes shown in FIGS. 2 and 3. The charging equipment used in this method is configured to be able to automatically charge an electrified vehicle (see FIG. 1). In S11 and S12 of FIG. 2, user authentication is performed through communication between the charging equipment and a user terminal linked to the electrified vehicle. If the user authentication is successful and the charging equipment becomes able to charge the electrified vehicle, the user terminal is notified in S23 of FIG. 3 that the electrified vehicle can be charged.

In the above method, user authentication is performed through communication between the charging equipment and the user terminal. Therefore, even if the user of the electrified vehicle is located away from the electrified vehicle, the charging equipment can identify the user of the electrified vehicle prior to charging the electrified vehicle. This prevents the charging equipment from erroneously charging an electrified vehicle that is not intended for charging. Furthermore, even if the user of the electrified vehicle is located away from the electrified vehicle, the user can know that the electrified vehicle can now be charged by the above-mentioned notification sent to the user terminal. Therefore, the user of the electrified vehicle can easily determine whether to charge the electrified vehicle using the charging equipment based on the current situation. According to the above method, even in a situation where the user of the electrified vehicle is located away from the electrified vehicle, the charging equipment can easily automatically charge the electrified vehicle appropriately.

Performing the above user authentication means that the charging equipment receives an electronic key that can identify an individual from the user terminal (S11 in FIG. 2), and that the charging equipment uses the electronic key to determine the success or failure of user authentication (S12 in FIG. 2). Notifying the user terminal (S23 in FIG. 3) includes notifying the user terminal of information regarding the enabled charging of the electrified vehicle. The method for charging an electrified vehicle described above further includes the step of the user terminal notifying the user of information regarding charging of the electrified vehicle and accepting an input as to whether to permit charging of the electrified vehicle (see screen Sc1 in FIG. 3). The information regarding charging includes at least one of charging time, scheduled charging end time, charging end conditions, and charging fee information (see screen Sc1 in FIG. 3). According to such a method, it becomes easier for charging equipment to perform user authentication quickly and appropriately. Furthermore, the user of the electrified vehicle can determine whether to permit charging of the electrified vehicle based on information regarding charging of the electrified vehicle. This improves the convenience of the user.

The method for charging an electrified vehicle includes the charging equipment sequentially charging a first electrified vehicle (vehicle 100B) and a second electrified vehicle (vehicle 100A) existing within a predetermined range (any of parking slots P1 to P4). Charging the first and second electrified vehicles in sequence means performing user authentication through communication between the charging equipment and the user terminal linked to the second electrified vehicle while charging the first electrified vehicle (S11, S12 in FIG. 2), and notifying the user terminal of the second electrified vehicle that charging of the second electrified vehicle is now possible after the charging of the first electrified vehicle is completed (S23 in FIG. 3); requesting permission to charge the second electrified vehicle using the charging equipment to the user terminal of the second electrified vehicle (S23-S25 and screens Sc1 and Sc2 in FIG. 3), and when the user terminal of the second electrified vehicle permits charging of the second electrified vehicle, and starting charging of the second electrified vehicle by the charging equipment (S26-S28 in FIG. 3). According to such a method, the user of the second electrified vehicle can know that the charging of the first electrified vehicle has finished even if the user is waiting for the charging of the first electrified vehicle to finish at a location away from the second electrified vehicle. Then, the user of the second electrified vehicle can start charging the second electrified vehicle by allowing charging of the second electrified vehicle.

Starting charging of the second electrified vehicle involves opening the charging lid of the second electrified vehicle to expose the charging port of the second electrified vehicle (S27 in FIG. 3), and connecting the charging connector section of the charging equipment to the charging port of the second electrified vehicle (S27 in FIG. 3), and supplying power from the charging connector section of the charging equipment to the charging port of the second electrified vehicle (S28 in FIG. 3). In such a method, when the user of the second electrified vehicle permits charging equipment to charge the second electrified vehicle after the charging of the first electrified vehicle is completed, contact charging of the second electrified vehicle is performed. Therefore, according to the above method, the user of the second electrified vehicle can charge the second electrified vehicle even if the user is located away from the second electrified vehicle.

The charging equipment may be configured to automatically charge an electrified vehicle, and is not limited to the movable charging equipment shown in FIG. 1.

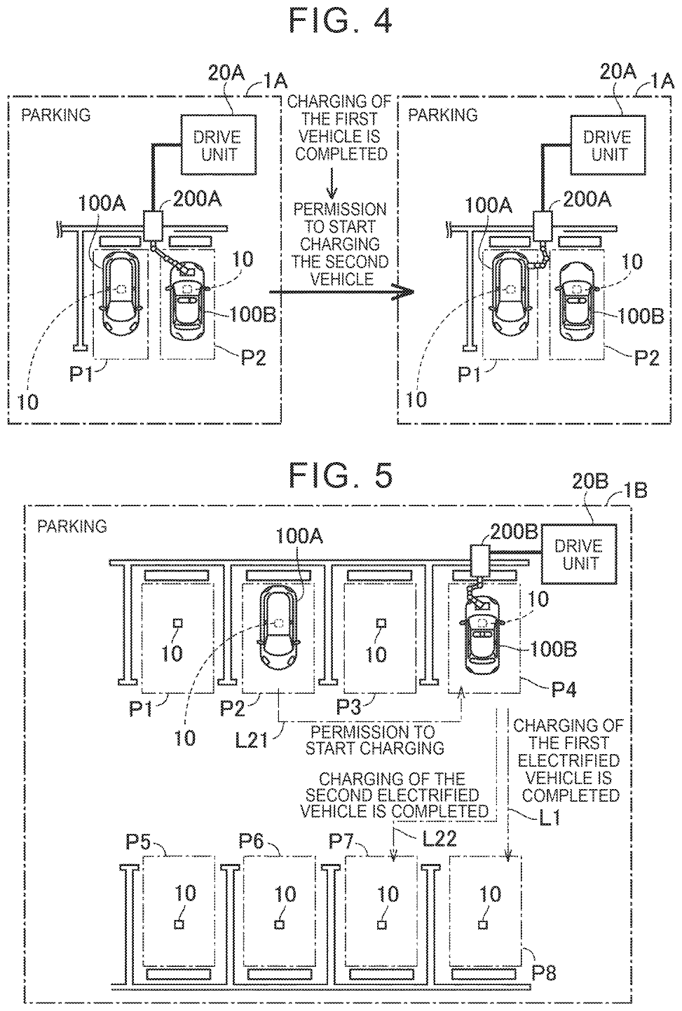

FIG. 4 is a diagram showing a first modification of the charging equipment. The charging equipment installed in the parking lot 1A shown in FIG. 4 includes a fixed electric vehicle supply equipment (EVSE) 200A and a drive unit 20A. Drive unit 20A includes a control device and power circuit (not shown) for EVSE 200A. The EVSE 200A is configured to be able to charge a plurality of electrified vehicles (vehicles 100A, 100B) parked in different parking slots. In S27 of FIG. 3, the control device opens the charging lid of the vehicle 100A and connects the charging connector portion of the EVSE 200A to the charging port of the vehicle 100A without moving the EVSE 200A.

FIG. 5 is a diagram showing a second modification of the charging equipment. The parking lot 1B shown in FIG. 5 has parking slots P1 to P8. The charging equipment installed in the parking lot 1B includes a fixed EVSE 200B and a drive unit 20B. Drive unit 20B includes a control device and power circuit (not shown) for EVSE 200B. EVSE 200B is configured to be able to charge an electrified vehicle parked in parking slot P4. The drive unit 20B (control device) executes automatic operation of the electrified vehicle by remote control at the start of charging and at the end of charging. For example, when charging of the vehicle 100B (first electrified vehicle) parked in the parking slot P4 is completed, the drive unit 20B moves the vehicle 100B to the parking slot P8 as shown by line L1 by remote control (S30 in FIG. 3). Thereafter, when the user of the vehicle 100A (second electrified vehicle) to be charged next permits charging to the charging equipment, the drive unit 20B moves the vehicle 100A to the parking slot P4 as shown by line L21 by remote control (S27 in FIG. 3). When charging of the vehicle 100A is completed, the drive unit 20B moves the vehicle 100A to the parking slot P7 by remote control as shown by line L22 (S30 in FIG. 3).

In the embodiment described above, a smartphone is used as the user terminal linked to the electrified vehicle, but the present disclosure is not limited to this type. For example, an HMI (for example, HMI 180) mounted on an electrified vehicle may be employed as a user terminal linked to the electrified vehicle.

In the embodiment described above, the charge end SOC is adopted as the charge termination condition. However, the present disclosure is not limited to this, and the charging termination conditions can be changed as appropriate. For example, the charge end time may be used instead of the charge end SOC. When the charging end time has elapsed from the start of charging, the charging end condition may be satisfied. Furthermore, the charging time (time from the start of charging to the end of charging) may be used instead of the scheduled charging end time (FIG. 3).

In the embodiment described above, the screen Sc2 shown in FIG. 3 receives input (change) of the charging end SOC from the user. However, the present disclosure is not limited to this, and the screen Sc2 may accept input (change) of charging time and/or charging fee from the user.

The above-described method or system may be applied to electrified vehicles other than BEVs, such as plug-in hybrid electric vehicles (PHEVs) or fuel cell electric vehicles (FCEVs). The charging equipment may be configured to enable non-contact charging. It may be considered that such an electrified vehicle enters a state similar to the above-mentioned “plug-in state” when the alignment between the power transmitting part (e.g., power transmitting coil) on the charging equipment side and the power receiving part (e.g., power receiving coil) on the vehicle side is completed.

The embodiments disclosed herein are illustrative in all respects and are not restrictive. The scope of the present disclosure is indicated by the claims rather than the description of the embodiments described above, and includes all changes within the meaning and scope equivalent to the claims.

What is claimed is:

1. A method of charging an electrified vehicle using charging equipment configured to automatically charge the electrified vehicle, the method comprising:
performing user authentication through communication between the charging equipment and a user terminal linked to the electrified vehicle; and
when the user authentication is successful and the charging equipment is able to charge the electrified vehicle, notifying the user terminal that the electrified vehicle is chargeable.

2. The method according to claim 1, wherein:
the performing of the user authentication includes
receiving, by the charging equipment, an electronic key that allows specifying an individual from the user terminal, and
determining, by the charging equipment, whether the user authentication is successful using the electronic key;
the notifying of the user terminal includes notifying the user terminal of information about charging of the electrified vehicle that has been enabled;
the method of charging an electrified vehicle further comprises
informing, by the user terminal, a user of the information about the charging of the electrified vehicle, and
accepting an input as to whether to permit the charging of the electrified vehicle; and
the information about the charging includes at least one of a charging time, a scheduled charging end time, a charging end condition, and charging fee information.

3. The method according to claim 1, further comprising sequentially charging, by the charging equipment, a first electrified vehicle and a second electrified vehicle existing within a predetermined range, wherein
the sequentially charging the first and second electrified vehicles includes:
performing user authentication through communication between the charging equipment and a user terminal linked to the second electrified vehicle during charging of the first electrified vehicle;
after the charging of the first electrified vehicle is finished, notifying the user terminal of the second electrified vehicle that charging of the second electrified vehicle is enabled;
requesting permission from the user terminal of the second electrified vehicle for the charging equipment to execute the charging of the second electrified vehicle; and
starting, by the charging equipment, the charging of the second electrified vehicle when the user terminal of the second electrified vehicle permits the charging of the second electrified vehicle.

4. The method according to claim 3, wherein the starting of the charging of the second electrified vehicle includes:
opening a charging lid of the second electrified vehicle to expose a charging port of the second electrified vehicle;
connecting a charging connector portion of the charging equipment to the charging port of the second electrified vehicle; and
supplying power from the charging connector portion of the charging equipment to the charging port of the second electrified vehicle.

5. An electrified vehicle charging system comprising charging equipment that executes the method of charging an electrified vehicle according to claim 1.
